(19) United States
(12) Patent Application Publication
(10) Pub. No.: US 2025/0173643 A1
(43) Pub. Date: May 29, 2025

(54) SUPPORT APPARATUS, SUPPORT METHOD, AND PROGRAM

(71) Applicant: NTT TechnoCross Corporation, Tokyo (JP)

(72) Inventors: Toshihiko TANAKA, Tokyo (JP); Kazuhira MATSUI, Tokyo (JP); Kenichi MACHIDA, Tokyo (JP)

(73) Assignee: NTT TechnoCross Corporation, Tokyo (JP)

(21) Appl. No.: 18/839,768

(22) PCT Filed: Feb. 22, 2022
(86) PCT No.: PCT/JP2022/007271

§ 371 Date: Aug. 20, 2024

(51) Int. Cl. G06Q 10/0631; G06F 9/451; G06Q 10/067; G10L 15/22; H04M 3/51

(52) U.S. Cl. CPC G06Q 10/063112; G06F 9/451; G06Q 10/067; G10L 15/22; H04M 3/51

(57) ABSTRACT

A support apparatus according to one embodiment is a support apparatus for supporting a specific task. The support apparatus includes an organization information storage storing organization information indicating a relationship between a hierarchical structure of organization and users belonging to the organization, and an identifying part configured to, when a user initiates a chat with another user, identify another user who will be a partner of the chat for the user with reference to the organization information.

### TECHNICAL FIELD

The present invention relates to support apparatuses, support methods, and programs.

### BACKGROUND ART

In recent years, an application called business chat has been used as a communication tool in corporations (e.g., Non-Patent Document 1). There are various call center (or also called contact center) systems into which a chat function is installed together with a voice recognition function, a FAQ function, and the like. For example, the chat function is used for communication between an operator and a supervisor for the purpose of improving quality of customer service. Note that, the FAQ function may be also referred to as a knowledge function.

### Citation List

### Non-Patent Document

Non-Patent Document 1: “elgana” internet <URL: https://elgana.jp/>

### SUMMARY OF INVENTION

### Technical Problem

However, the chat function available in the related art cannot always sufficiently support tasks of operators or supervisors.

For example, when an operator initiates a chat with a supervisor, the operator needs to select the supervisor as a chat partner from a list of users. Therefore, it may take some time to start the chat, which may lower the quality of customer service. Moreover, the chat function is limited, for example, to a communication tool between the operator and the supervisor, and the chat result cannot be sufficiently utilized for construction of knowledge, analysis of the contents of the call, and the like.

One aspect of the present invention has been made considering the above points, and an object thereof is to realize a support of a specific task.

### Solution to Problem

To achieve the above object, a support apparatus according to one aspect is a support apparatus for supporting a specific task. The support apparatus includes an organization information storage storing organization information indicating a relationship between a hierarchical structure of an organization and users belonging to the organization, and an identifying part configured to, when a user initiates a chat with another user, identify another user who will be a partner of the chat for the user with reference to the organization information.

### Advantageous Effects of Invention

Support for a specific task can be realized.

### BRIEF DESCRIPTION OF DRAWINGS

FIG. 1 is a diagram illustrating one example of an overall configuration of a contact center system according to the present embodiment.

FIG. 2 is a diagram illustrating one example of a functional configuration of a task support apparatus according to the present embodiment.

FIG. 3 is a diagram for explaining one example of organization information.

FIG. 4 is a diagram for explaining one example of a service support screen.

FIG. 5 is a flowchart illustrating one example of a process of identifying a chat partner.

FIG. 6 is a diagram for explaining one example of a voice recognition log and a chat log.

FIG. 7 is a diagram for explaining one example of extraction of question sentences and answer sentences.

FIG. 8 is a flowchart illustrating one example of a process of constructing knowledge.

FIG. 9 is a diagram for explaining one example of a service check screen.

FIG. 10 is a flowchart illustrating one example of a process of displaying a service check screen.

FIG. 11 is a diagram for explaining another example of the service check screen (part 1).

FIG. 12 is a diagram for explaining another example of the service check screen (part 2).

FIG. 13 is a diagram for explaining one example of a filtering process.

### DESCRIPTION OF EMBODIMENTS

Hereinafter, an embodiment of the present invention will be described. In the present embodiment, a contact center system 1 that can support tasks of an operator or a supervisor will be explained with a contact center as an application target. Here, the tasks of the operator include, for example, a task of responding to a phone call from a client, an after-call work (ACW), such as preparation of an order slip based on the conversation with the client after the phone call with the client, and the like. Meanwhile, the tasks of the supervisor include, for example, a task of answering an inquiry from an operator, when receiving the inquiry from the operator via a chat function, to support the operator to respond a phone call, a task of monitoring a call of an operator, a task of analyzing the contents of the calls of each operator, a task of constructing knowledge, such as FAQ, and the like. However, it is needless to say that the above tasks are merely some of examples, and the operator and the supervisor can carry out various tasks other than the above. Moreover, the above tasks may be carried out by someone other than the operator or supervisor. For example, the task of analyzing the contents of the calls of each operator may be carried out by a person in charge of analysis, and the task of constructing knowledge may be carried out by a person in charge of knowledge construction.

Note that the contact center is an example of an application target, and the present embodiment can be similarly applied to a case where, for example, an office or the like is used as a target, and tasks of people working at the office, such as a task of responding to a phone call, ACW, a monitoring and supporting task, a call analysis task, a knowledge construction task, and the like are supported.

The contact center system 1 that realizes the following (1) to (3) will be explained hereinafter.
(1) When an operator initiates a chat, a chat partner is automatically identified so that the time until the chat starts will be shortened.
(2) Knowledge is constructed by utilizing the contents of the chat as well as the contents of a phone call between a customer and the operator.
(3) When the contents of the phone call are checked afterward or in the background, the contents of the phone call and the contents of the chat are displayed in association with each other.

According to above (1), for example, a task of responding to a phone call of a customer becomes efficient so that quality of customer service is improved. According to above (2), for example, more useful knowledge (FAQ) is constructed so that quality of customer service is improved and a knowledge construction task becomes efficient. According to above (3), for example, after-call work (ACW), a task of analyzing contents of a call, and the like become efficient so that quality of customer service can be improved.

### Overall Configuration of Contact Center System

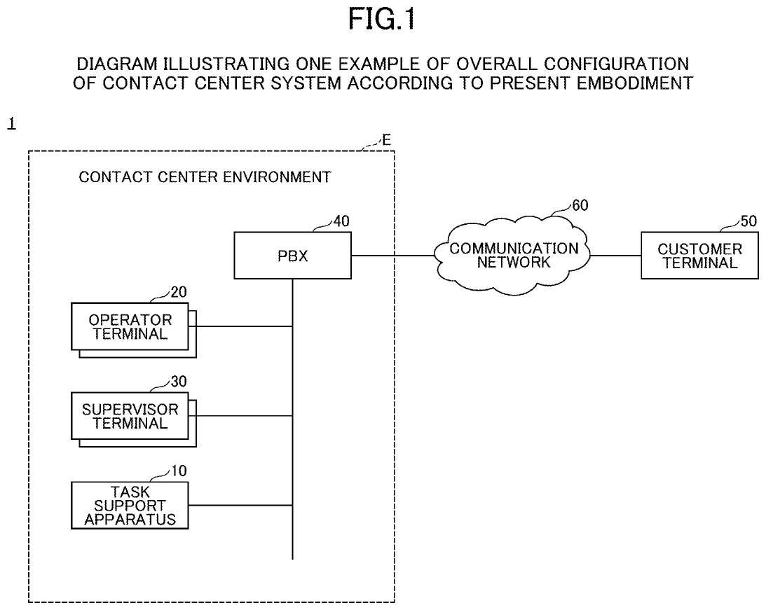

FIG. 1 illustrates an example of an overall configuration of the contact center system 1 according to the present embodiment. As illustrated in FIG. 1, the contact center system 1 according to the present embodiment includes a task support apparatus 10, one or more operator terminals 20, one or more supervisor terminals 30, a private branch exchange (PBX) 40, and a customer terminal 50. Here, the task support apparatus 10, the one or more operator terminals 20, the one or more supervisor terminals 30, and the PBX 40 are installed in a contact center environment E that is a system environment of a contact center. Note that, the contact center environment E is not limited to a system environment in the same building, and may be, for example, a system environment across multiple buildings that are geographically separated from one another.

The task support apparatus 10 converts a voice call between a customer and an operator into texts in real time by voice recognition, and displays a screen including the texts, contents of the chat between the operator and the chat partner, and knowledge (FAQ) searched by the operator (hereinafter, may be also referred to as a service support screen) on the operator terminal 20. Moreover, the task support apparatus 10 generates knowledge information (FAQ information) from the contents of the call and the contents of the chat to construct knowledge. Further, the task support apparatus 10 displays a screen enabling to check the contents of the call and the contents of the chat of the operator, which are associated with each other, afterward or in background (may be also referred to as a service check screen hereinafter) on the operator terminal 20 or the supervisor terminal 30.

The operator terminal 20 is a terminal of various types, such as a personal computer (PC) used by the operator, and functions as an internet protocol (IP) telephone. During a call with a customer, a service support screen is displayed on the operator terminal 20. Moreover, after the call, a service check screen regarding the call made by the operator, and the chat during the call can be displayed on the operator terminal 20.

The supervisor terminal 30 is a terminal of various types, such as a personal computer (PC) used by the supervisor. The supervisor terminal 30 can display a service check screen regarding the call and the chat during the call after the call or in background during the call. Note that, the supervisor is a person who monitors a call of an operator, and supports a task of the operator to respond to a phone call when some problem may be likely to occur or in response to a request from the operator. In general, one supervisor typically monitors calls of approximately two or more operators to less than twenty operators.

The PBX 40 is a telephone exchange (IP-PBX), and is connected to a communication network 60 including a voice over internet protocol (VoIP) network or a public switched telephone network (PSTN). When a call from a customer terminal 50 is received, the PBX 40 calls one or more predetermined operator terminals 20, and connects the customer terminal 50 with any of the operator terminals 20 that have responded to the call.

The customer terminal 50 is a terminal of various types, such as a smartphone, a mobile phone, a landline phone, and the like used by a customer.

Note that, the overall configuration of the contact center system 1 illustrated in FIG. 1 is one example, and the contact center system 1 may have another configuration. For example, in the example illustrated in FIG. 1, the task support apparatus 10 is included in the contact center environment E (that is, the task support apparatus 10 is an on-premise type), but all or some of the functions of the task support apparatus 10 may be implemented by a cloud service or the like. Similarly, in the example illustrated in FIG. 1, the PBX 40 is an on-premise telephone exchange, but may be implemented by a cloud service.

### Functional Configuration of Task Support Apparatus 10

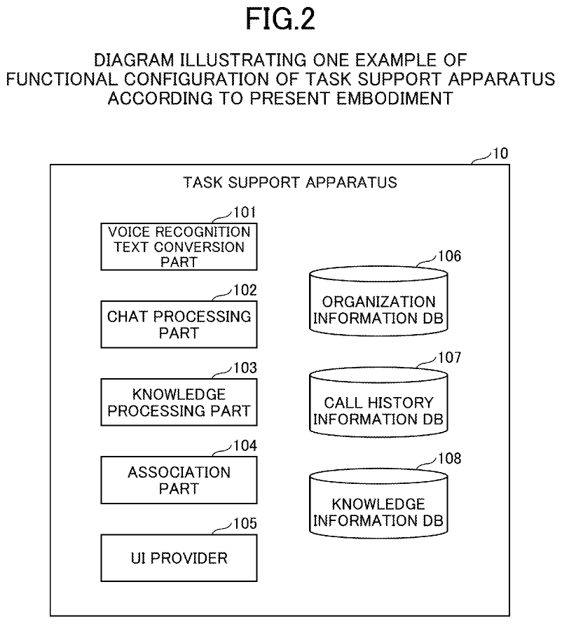

FIG. 2 illustrates a functional configuration of the task support apparatus 10 according to the present embodiment. As illustrated in FIG. 2, the task support apparatus 10 according to the present embodiment includes a voice recognition text conversion part 101, a chat processing part 102, a knowledge processing part 103, an association part 104, and a UI provider 105. The above parts are implemented, for example, by executing one or more programs installed in the task support apparatus 10 by a processor, such as a central processing unit (CPU) or the like.

Moreover, the task support apparatus 10 according to the present embodiment includes an organization information DB 106, a call history information DB 107, and a knowledge information DB 108. The above databases (DB) are implemented, for example, by an auxiliary storage device, such as a hard disk drive (HDD), a solid state drive (SSD), or the like. At least one of the above DBs may be implemented, for example, by a database server or the like connected to the task support apparatus 10 via a communication network.

The voice recognition text conversion part 101 converts a voice call between the operator terminal 20 and the customer terminal 50 into texts by voice recognition. At this time, the voice recognition text conversion part 101 performs voice recognition for each speaker to convert into texts. Thus, the operator's voice and the customer's voice are each converted into texts. The texts obtained by voice recognition may be also referred to as “voice recognition texts” hereinafter. The voice recognition texts are displayed on a service support screen in real time.

When the operator is making a voice call with the customer, the chat processing part 102 sends and receives chat messages (for example, relays chat messages between the operator terminal 20 and the supervisor terminal 30) between the operator making the voice call and a person (e.g., a supervisor) supporting the task of the operator to respond to the phone call. When the operator initiates a chat, the chat processing part 102 automatically specifies a user who will be a partner of the chat of the operator with reference to the organization information stored in the organization information DB 106. Here, the chat message is often a message represented by texts, but the representation of the chat message is not limited to the texts. For example, the chat message may be a message represented by a stamp, an image, or the like. The chat messages are displayed on the service support screen in real time.

When the operator is on the voice call with the customer, the knowledge processing part 103 searches knowledge information (FAQ information) from the knowledge information DB 108 in response to an operation of the operator on the voice call, and transmits the searched knowledge information to the operator terminal 20. When the operator terminal 20 receives the knowledge information, knowledge represented by the knowledge information is displayed on the service support screen.

Moreover, the knowledge processing part 103 generates knowledge information from the voice recognition log and the chat log included in the call history information stored in the call history information DB 107. Here, the voice recognition log is a set of voice recognition texts of the call represented by the call history information, and the chat log is a set of chat messages for the call represented by the call history information.

The association part 104 associates the voice recognition texts with the chat messages in chronological order when the service check screen is displayed on the operator terminal 20 or the supervisor terminal 30.

The UI provider 105 provides display information for displaying a service support screen, display information for displaying a service check screen, or the like to the operator terminal 20, the supervisor terminal 30, or the like.

The organization information DB 106 stores organization information representing a structure of an organization to which users, such as an operator and a supervisor, belong. The organization information will be described in detail later. Note that, the organization information is updated as appropriate when, for example, the structure of the organization is changed, a user is added or deleted, there is a transfer within the organization, or the like.

The call history information DB 107 stores call history information indicating information on a call The call history information includes, for history. example, information, such as a call ID for uniquely identifying a call, a time and date of the call, duration of the call, a user ID for uniquely identifying an operator responding to the call, an extension number of the operator, a telephone number of a customer, voice recognition texts of the call (a voice recognition log), chat messages (chat log), and the like. Note that, the call history information is generated for each call between a customer and an operator, and is stored in the call history information DB 107.

The knowledge information DB 108 stores knowledge information including question sentences and answer sentences responding to the question sentences. When knowledge information is searched from the knowledge information DB 108, for example, a search keyword may be compared with the question sentences included in the knowledge information, or the search keyword may be compared with key information when the knowledge information includes key information indicating keywords for search and the like.

### Organization Information

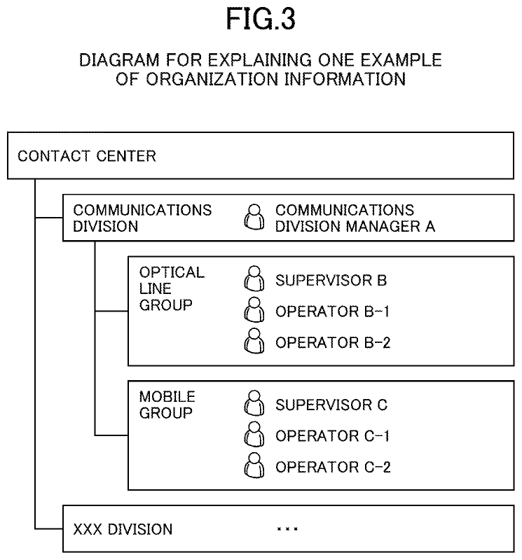

FIG. 3 illustrates one example of the organization information stored in the organization information DB 106. As illustrated in FIG. 3, the organization information is information indicating a relationship between a hierarchical structure of an organization, such as departments, groups, and the like, constituting the contact center and users belonging to the organization.

In the example illustrated in FIG. 3, for example, the contact center is composed of the organization, such as “Telecommunication Division,” “ . . . Division,” and the like, and moreover, the “Telecommunications Division” is composed of “Optical Line Group,” “Mobile Group,” and the like. Moreover, “Telecommunications Division Manager A” belongs to the “Telecommunications Division.” Similarly, “Supervisor B,” “Operator B-1,” “Operator B-2,” and the like belong to the “Optical Line Group,” and “Supervisor C,” “Operator C-1,” “Operator C-2,” and the like belong to the “Mobile Group.”

As described above, the organization information is information defining a hierarchical structure of organization constituting the contact center and user ID of users (managers, supervisors, operators, etc.) belonging to the organization. Thus, it is possible to identify a supervisor for monitoring, supporting each operator or the like as a chat partner for the operator, or identify a manager belonging to the higher level of the organization, with reference to the organization information.

The example illustrated in FIG. 3 is one example, and the organization information is not limited to the example illustrated in FIG. 3. For example, in the example illustrated in FIG. 3, the contact center is composed of the three levels of the organization, but the organization may be composed of less than three levels, or four or more levels.

### Service Support Screen

As described above, during the voice call between the customer and the operator, the service support screen is displayed on the display of the operator terminal 20 of the operator.

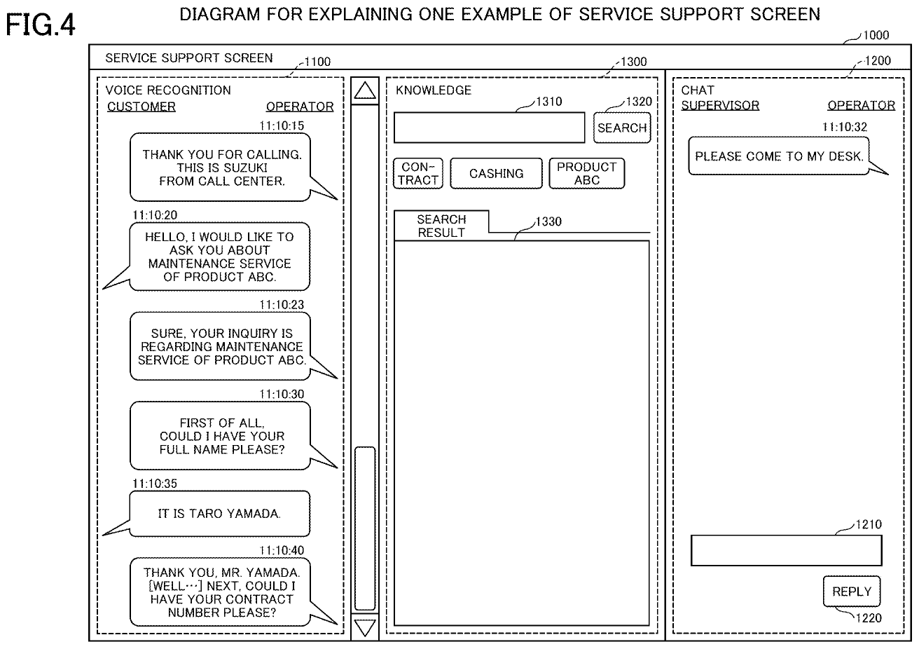

FIG. 4 illustrates one example of the service support screen. The service support screen 1000 illustrated in FIG. 4 includes a voice recognition column 1100, a chat column 1200, and a knowledge column 1300.

In the voice recognition column 1100, voice recognition texts converted by the voice recognition text conversion part 101 are displayed in real time. Note that, the voice recognition text conversion part 101 captures a voice packet representing speech from the customer to the operator and a voice packet representing speech from the operator to the customer, and performs voice recognition on each of the voice packets to generate a voice recognition text representing each speech from the customer and the operator in real time (that is, substantially without any delay). In the example illustrated in FIG. 4, the voice recognition texts representing the speech from the customer are displayed on the left side, and the voice recognition texts representing the speech from the operator are displayed on the right side.

In the chat column 1200, chat messages with a chat partner identified by the chat processing part 102 are displayed in real time. In the example illustrated in FIG. 4, a supervisor is identified as the chat partner, and the chat messages between the identified supervisor and the operator are displayed.

Moreover, the chat column 1200 includes a message input column 1210 and a send button 1220. As the send button 1220 is pressed in a state where a message is input in the message input column 1210, the message is sent to the chat partner via the task support apparatus 10.

Specifically, as the send button 1220 is pressed in a state where a message is input in the message input column 1210, the operator terminal 20 transmits the message to the task support apparatus 10. Then, the chat processing unit 102 of the task support apparatus 10 transmits the message received from the operator terminal 20 to a terminal of the chat partner (e.g., the supervisor terminal 30 of the supervisor monitoring and supporting the operator). Thus, the message is displayed on the terminal of the chat partner. When a message is received from the terminal of the chat partner via the task support apparatus 10, the operator terminal 20 displays the message in the chat column 1200.

The knowledge column 1300 includes a search keyword input column 1310, a search button 1320, and a search result display column 1330. As the search button 1320 is pressed in a state where a search keyword is input in the search keyword input column 1310, a question sentence and an answer sentence included in the knowledge information searched by the search keyword are displayed in the search result display column 1330.

Specifically, as the search button 1320 is pressed in a state where a search keyword is input in the search keyword input column 1310, the operator terminal 20 transmits a search request including the search keyword to the task support apparatus 10. Then, the knowledge processing part 103 of the task support apparatus 10 searches the knowledge information from the knowledge information DB 108 using the search keyword included in the search request, and transmits the search result including the searched knowledge information to the operator terminal 20. Accordingly, the question sentence and the answer sentence of the knowledge information included in the search result are displayed in the search result display column 1330 of the knowledge column 1300 included in the service support screen 1000 of the operator terminal 20.

In this way, the service support screen 1000 including the voice recognition column 1100, the chat column 1200, and the knowledge column 1300 is displayed on the operator terminal 20 during the voice call between the customer and the operator. Therefore, the operator can check the voice recognition column 1100 to grasp the contents of the call with the customer, request a support to a supervisor or the like in the chat column 1200, or check the knowledge (FAQ) in the knowledge column 1300.

### Identifying Chat Partner

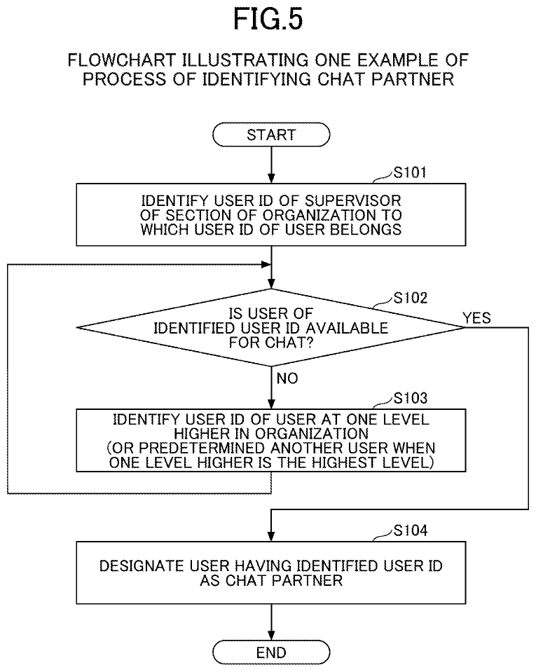

A process of identifying a chat partner when an operator initiates a chat will be explained hereinafter with reference to FIG. 5.

First, the chat processing part 102 specifies a user ID of a supervisor belonging to an organization to which a user ID of the operator belongs, with reference to organization information stored in the organization information DB 106 (step S101). For example, in the example illustrated in FIG. 3, the user ID of “Supervisor B” is identified in the case where the operator belongs to the “Optical Line Group.” Note that, in general, the supervisor belonging to the organization (group) to which the operator belongs has a task of monitoring and supporting the operator as a normal task. Therefore, this supervisor is usually a chat partner for the operator.

Next, the chat processing part 102 determines whether a user having the user ID identified in step S101 is available for a chat (step S102). Examples of a case where it is determined that the user is not available for the chat include a case where the user having the user ID is on holiday, a case where the user having the user ID is in a meeting, a case where the user having the user ID is not at the desk, a case where the user having the user ID is not available for a chat due to any other reasons, and the like.

In the case where it is determined that the user is not available for a chat in step S102, the chat processing part 102 specifies a user ID of a user at one level higher (or predetermined another user if the one level higher is the highest level of the organization) with reference to the organization information stored in the organization information DB 106 (step S103), and returns to step S102.

For example, in the example illustrated in FIG. 3, in a case where the operator belongs to the “Optical Line Group” and the “Supervisor B” having the user ID identified in step S101 is not available for a chat, a user ID of “Communications Division Manager A” who is a user belonging to the “Communications Division” of one level is identified.

Moreover, in the example illustrated in FIG. 3, for example, in a case where one higher level of the organization to which the user having the user ID identified in this step is “Contact Center,” a user ID of a predetermined another user is identified. Examples of the predetermined another user include a user of another section of the organization that is the same level as the section of the organization the unavailable user belongs to (a user of “ . . . Division” or the like in a case where the user having the user ID identified by this step is “Telecommunications Division Manager A” in the example illustrated in FIG. 3), and a supervisor of another section of the organization in the same level as the section of the organization to which the operator belongs to (“Supervisor C” of the “Mobile Group” or the like in the example of FIG. 3).

In the case where it is determined that the user is available for a chat in S102, the chat processing part 102 determines the user of the finally identified user ID as a chat partner for the operator (step S104). Thus, the chat partner for the operator is identified. Therefore, when the operator initiates a chat, for example, the chat can be efficiently started without an operation of selecting a chat partner (particularly, a supervisor monitoring and supporting the operator) from the list of users. As a result, for example, an answer from a supervisor or the like can be obtained quickly by the chat, a waiting time of the customer can be reduced, and quality of customer service can be improved.

The above process of identifying the chat partner may be performed, for example, when the operator starts daily tasks, or may be performed for each call. In a case where the process of identifying the chat partner is performed when the operator starts daily tasks, the chat partner is the same throughout the day. Conversely, in a case where the process is performed for each call, the chat partner may change for each call. In addition, for example, the process of identifying the chat partner may be performed at predetermined time intervals such as every hour, or the process of identifying the chat partner may be performed again when the identified chat partner becomes unavailable for a chat.

### Construction of Knowledge

Construction of knowledge from the voice recognition log and the chat log included in certain call history information stored in the call history information DB 107 will be explained hereinafter. In the following description, it is assumed that the chat log is a log of chat messages between an operator and a supervisor.

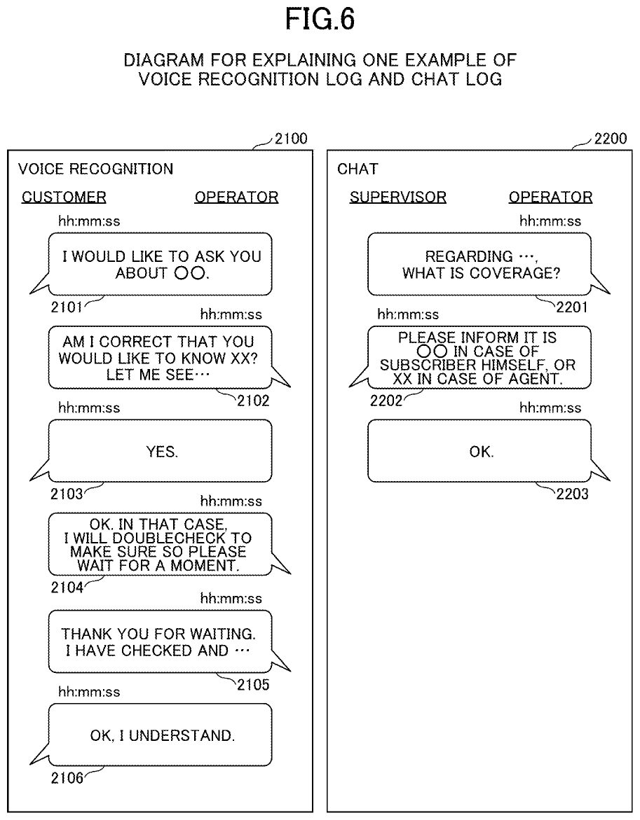

As an example, the voice recognition log 2100 and the chat log 2200 illustrated in FIG. 6 are assumed as the voice recognition log and the chat log. The voice recognition log 2100 illustrated in FIG. 6 is composed of voice recognition texts 2101 to 2106. The chat log illustrated in FIG. 6 is composed of chat messages 2201 to 2203.

Here, each voice recognition text in the voice recognition log is generally provided with a time and date of speech t, and a speaker x₁ of the speech. Specifically, if a voice recognition text is determined as y₁, the voice recognition text is represented as (t, x₁, y₁). Thus, the voice recognition log is represented as {(t, x₁, y₁)|t∈ET₁}. Note that, T₁ is a set of values that the time and date of the speech t can take. Moreover, x₁ is a flag that can take a value indicating either a customer or an operator. For example, a case of x₁ being 0 (x₁=0) indicates a customer, and a case of x₁ being 1 (x₁=1) indicates an operator.

Similarly, each chat message of the chat log is provided with a time and date of a message t and a sender x₂ of the message. Specifically, if a chat message is determined as y₂, the chat message is represented as (t, x₂, y₂). Thus, the chat log is represented as {(t, x₂, y₂)|t∈T₂}. Note that, T₂ is a set of values that the time and date of the message t can take. Moreover, x₂ is a flag that can take a value indicating either a chat partner or an operator. For example, a case of x₂ being 0 (x₂=0) indicates a supervisor, and a case of x₂ being 1 (x₂=1) indicates an operator.

At this time, a voice recognition text-chat message set {(t, x, y)|t∈T₁∪T₂} is generated. The voice recognition text-chat message set is a set where voice recognition texts included in the voice recognition log and chat messages included in the chat log are associated in chronological order (in other words, a set arranged in chronological order). When t belongs to T₁ (t∈T₁), x is x₁ (x=x₁) and y is y₁ (y=y₁). When t belongs to T₂ (t∈T₂), x is x₂ (x=x₂) and y is y₂ (y=y₂). Note that, a case of t∈T₁∩T₂ may occur. In such a case, (t, x₁, y₁) and (t, x₂, y₂) may be included in the voice recognition text-chat message set in this order with respect to the same t.

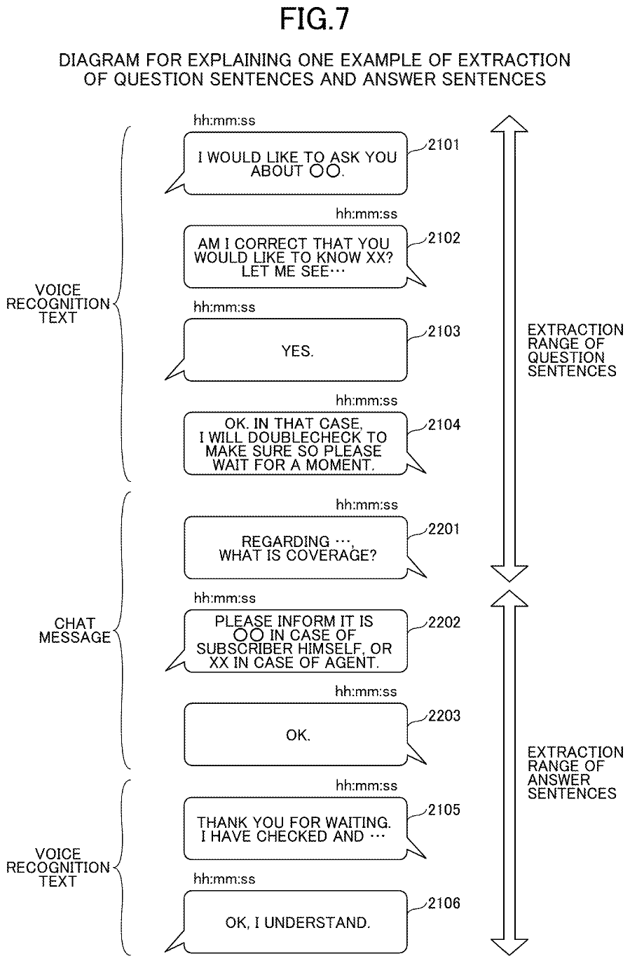

For example, the voice recognition text-chat message set, in which the voice recognition texts 2101 to 2106 included in the voice recognition log 2100 illustrated in FIG. 6 and the chat messages 2201 to 2203 included in the chat log 2200 illustrated in FIG. 6 are arranged in chronological order is as illustrated in FIG. 7.

Then, the voice recognition texts and chat messages extracted as question sentences and the voice recognition texts and chat messages extracted as answer sentences are identified from the above voice recognition text-chat message set. In general, in a contact center, questions are often asked from a customer to an operator and from the operator to a supervisor, and answers are often provided from the supervisor to the operator and from the operator to the customer. Therefore, the voice recognition texts and chat messages extracted as question sentences and the voice recognition texts and chat messages extracted as answer sentences from the voice recognition text-chat message set are identified considering the above nature of the questions and answers. Specifically, within the voice recognition text-chat message set, inquiry speech or question speech of a customer and repetition speech of an operator in response to the inquiry or question until chat message appears, and the chat message for the inquiry or question are extracted as question sentences. Chat texts of a supervisor appearing after the chat message extracted as the question sentence, and explanatory speech of the operator after the end of the chat are extracted as answer sentences. Note that, a type of speech (a type indicating inquiry speech, question speech, or explanatory speech) can be identified by an existing technology.

For example, in the example illustrated in FIG. 7, the voice recognition texts 2101 to 2102 and the chat message 2201 are extracted as the question sentences, and the chat message 2202 and the voice recognition text 2105 are extracted as the answer sentences. Thus, knowledge (FAQ) information can be generated by an existing technology using the extracted question sentences and answer sentences. In the existing technology for generating knowledge information, knowledge information including question sentences and answer sentences are generated by identifying a corresponding answer sentence that is an answer of each of the question sentences.

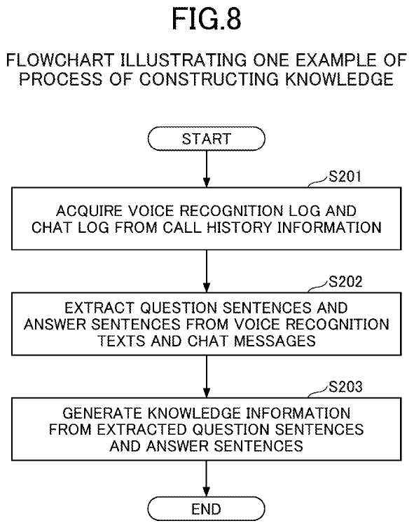

The process for generating the knowledge information (construction of knowledge) described above will be explained with reference to FIG. 8.

First, the knowledge processing part 103 acquires a voice recognition log and chat log from the call history information stored in the call history information DB 107 (step S201).

Next, the knowledge processing part 103 extracts question sentences and answer sentences from the voice recognition log and chat log acquired in above step S201 (step S202). Note that, the extraction method of the question sentences and answer sentences are as described above.

Then, the knowledge processing part 103 generates knowledge information using the question sentences and answer sentences extracted in above step S203 (step S203). The knowledge information is stored in the knowledge information DB 108. Note that, the knowledge information may be generated by the existing technology as described above.

This generates knowledge information that the operator can search and check during the call. Since the knowledge information is generated not only from the contents of the past calls between the customer and the operator but also from, for example, the contents of the past chats between the supervisor and the operator, the knowledge information with higher accuracy than before can be generated.

### Service Check Screen

As described above, the operator can display a service check screen on the operator terminal 20 to check the contents of the call after the call is ended. Moreover, the supervisor can display the service check screen on the supervisor terminal 30 to check the contents of the past calls, or display the service check screen on the supervisor terminal 30 to check the contents of the call during the call of the operator whom the supervisor monitors and supports.

At least voice recognition texts and chat messages are displayed on the service check screen. In the following description, it is assumed that only the voice recognition texts and the chat messages are displayed on the service check screen, and the other display contents will not be described. However, it is needless to say that contents other than the voice recognition texts and the chat messages may be displayed on the service check screen.

For the sake of simplicity, it is assumed, in the following description, that the voice recognition texts and the chat messages displayed on the service check screen are the voice recognition texts 2101 to 2106 included in the voice recognition log 2100 and the chat messages 2201 to 2203 included in the chat log 2200 illustrated in FIG. 6.

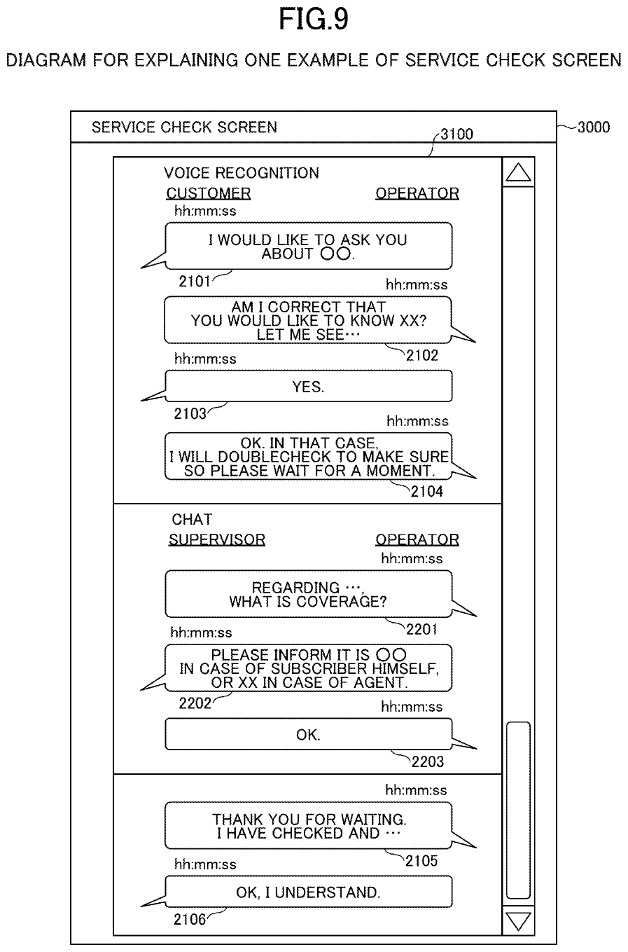

FIG. 9 illustrates one example of the service check screen. The service check screen 3000 illustrated in FIG. 9 includes a voice recognition text-chat message column 3100. In the voice recognition text-chat message column 3100, elements (i.e., voice recognition texts or chat messages) of the voice recognition text-chat message set {(t, x, y)|t∈T₁∪T₂} are displayed in chronological order. As described above, the voice recognition text-chat set {(t, x, y)|t∈T₁∪T₂} is a set in which the voice recognition log {(t, x₁, y₁)|t∈T₁} and the chat log {(t, x₂, y₂)|t∈T₂} are associated in chronological order.

In the example illustrated in FIG. 9, the voice recognition texts 2101 to 2104, the chat messages 2201 to 2203, and the voice recognition texts 2105 to 2106 are displayed in this order in the voice recognition text-chat message column 3100.

This enables the operator or the supervisor to check the voice recognition texts and the chat messages in association with each other, and to know, for example, what kind of chat has been made in what kind of flow of conversation during the call. Therefore, the operator can efficiently perform post work, such as ACW, and the supervisor can efficiently perform a task of analyzing contents of a call or the like. As a result, quality of customer service can be improved.

### Display of Service Check Screen

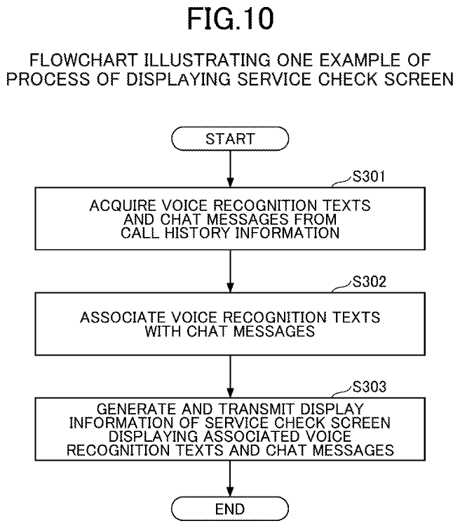

A process of displaying the service check screen on the operator terminal 20 or the supervisor terminal 30 will be explained with reference to FIG. 10. In the following description, a case where a service check screen including voice recognition texts and chat messages included in certain call history information within the call history information stored in the call history information DB 107 is displayed will be explained.

First, the association part 104 acquires a voice recognition log and chat log from the call history information (step S301).

Next, the association part 104 generates a voice recognition text-chat message set in which the voice recognition texts included in the voice recognition log acquired in above step S301 and the chat messages included in the chat log acquired in above step S301 are associated in chronological order (step S302).

Then, the UI provider 105 generates display information of a service check screen in which elements of the voice recognition text-chat message set generated in above step S302 are displayed in chronological order, and transmits the display information to the operator terminal 20 or the supervisor terminal 30 (step S303). Thus, the operator terminal 20 or the supervisor terminal 30 displays a service check screen based on the display information.

Although the case where the operator terminal 20 displays the service check screen regarding the call of the operator after the end of the call or the case where the supervisor terminal 30 displays the service check screen regarding the past call has been explained above, for example, the display of the service check screen can be similarly realized in a case where the supervisor terminal 30 displays the service check screen regarding an ongoing call in the background of the call. In this case, however, not only the call history information, but also voice recognitions texts and chat messages up to the current moment in the ongoing call are used.

### MODIFIED EXAMPLES

Modified examples of the present embodiment will be explained hereinafter.

### Modified Example 1

On a service check screen, a link button for referring to chat messages on another screen or the like may be displayed instead of the chat messages, without displaying the chat messages themselves. In this case, display information of such a service check display is generated by the UI provider 105 in step S303 of FIG. 10.

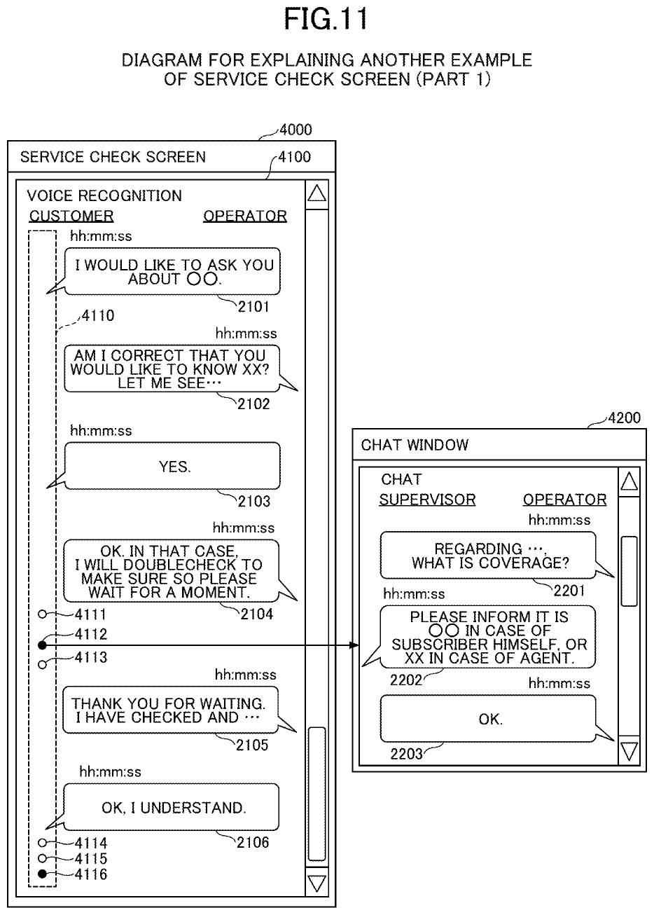

For example, the voice recognition text-chat message column 4100 of the service check screen 4000 illustrated in FIG. 11 includes a link button display column 4110, as well as displaying the voice recognition texts 2101 to 2106. Moreover, link buttons 4111 to 4116 for referring to the chat messages are displayed in the link button display column 4110. The link buttons are displayed in chronological order according to the time and dates of the chat messages corresponding to the link buttons, respectively, in relation with the voice recognition texts and other link buttons.

As any of these link buttons is pressed, a chat window 4200 is displayed, and a chat message corresponding to each link button is displayed in the chat window 4200.

In the example illustrated in FIG. 11, a case where the chat message 2202 corresponding to the link button 4112 is displayed in the center of the chat window 4200 by pressing the link button 4112 is illustrated. Note that, each link button is displayed in a different color depending on whether the link button is for a chat message of the operator or for a chat message of a chat partner (the supervisor in the example illustrated in FIG. 11).

Note that, in the example illustrated in FIG. 11, the chat window is a separate screen from the service check screen, but the chat window may be in the same screen as the service check screen.

### Modified Example 2

In the service check screen, only chat messages may be displayed, and voice recognition texts may be displayed in response to the selection of the user (the operator or supervisor). In this case, display information for such a service check screen is generated by the UI provider 105 in step S303 of FIG. 10.

For example, the chat messages 2201 to 2203 are displayed in the voice recognition text-chat message column 4100 of the service check screen 5000 illustrated in FIG. 11. As a user (the operator or supervisor) moves a mouse cursor or the like over the chat message 2201, for example, a selection window 5110 is displayed. In the selection window 5110, a “previous speech check” button for checking the speech immediately before the chat message 2201, and a “subsequent speech check” button for checking the speech immediately after the chat message 2201 are included.

As any of these buttons is pressed, a voice recognition window 5200 is displayed, and the voice recognition text corresponding to the pressed button is displayed in the voice recognition window 5200.

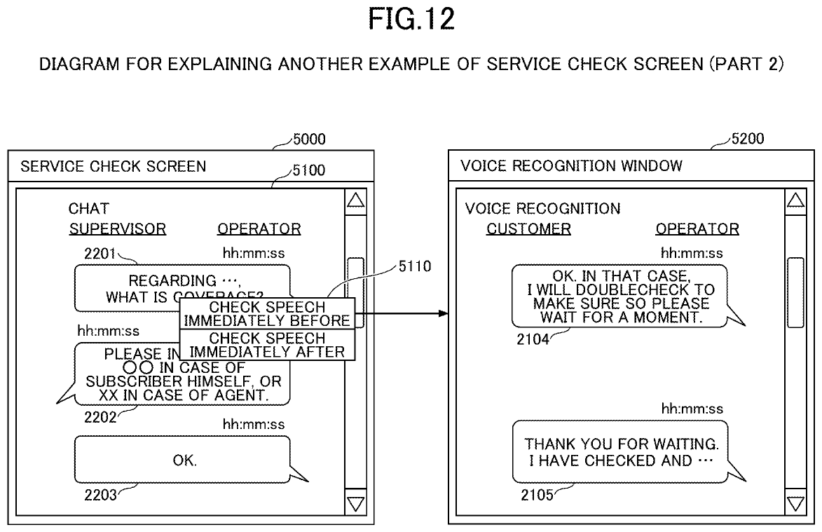

In the example illustrated in FIG. 12, the case where the “previous speech check” button in the selection window 5110 is pressed, and the voice recognition text 2104 corresponding to the button is displayed in the voice recognition window 5200 is illustrated.

Note that, the vice recognition window is a separate window from the service check window in the example illustrated in FIG. 12, but the voice recognition window may be in the same window as the service check window.

### Modified Example 3

In the above embodiments, the chat messages are explained as text messages, but the chat messages may be messages represented by stamps or images. In addition, among the chat messages, there are messages that merely express a reply, such as “Yes” or “Ok” and are not very useful for grasping the contents of the call or constructing knowledge. Moreover, one sentence may be divided into two or more chat messages and sent, which may not be suitable for grasping the contents of the call or constructing knowledge.

Therefore, a filtering process may be carried out on the chat messages to unify two or more chat messages, which constitutes one sentence, into one chat message, and to delete chat messages, such as stamps, images, “Yes,” “Ok,” and the like.

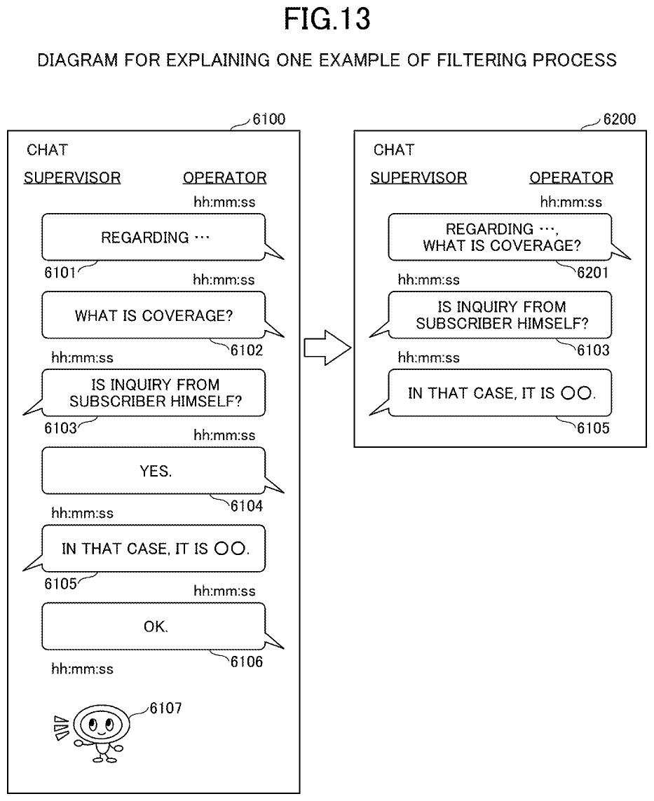

For example, the chat log 6100 illustrated in FIG. 13 is examined. The chat log 6100 is composed of the chat messages 6101 to 6107. A filtering process may be carried out on the chat log 6100 to generate a chat log 6200. In example illustrated in FIG. 13, the chat message 6104 indicating “Yes,” the chat message 6106 indicating “Ok,” and the chat message 6107 represented by the stamp are deleted. Moreover, the chat messages 6101 to 6102 are chat messages expressing one sentence in combination, thus the chat messages 6101 to 6102 are combined together as chat message 6201.

In this case, a voice recognition text-chat message set is generated using the chat log processed by the filtering process, when knowledge is constructed, or when a service check screen is displayed.

Note that, the above filtering process is merely one example, and other than the above filtering process, for example, a specific expression may be converted or processed into another expression. For such a filtering process, an existing filtering process used in natural language processing may be employed, and can be realized by an existing technique.

The present invention is not limited to the above embodiments, which have been specifically disclosed, and various modifications or changes, combination with existing techniques, and the like are possible without departing from the scope as claimed.

### REFERENCE SIGNS LIST

1 contact center system
10 task support apparatus
20 operator terminal
30 supervisor terminal
40 PBX
50 customer terminal
60 communication network
101 voice recognition text conversion part
102 chat processing part
103 knowledge processing part
104 association part
105 UI provider
106 organization information DB
107 call history information DB
108 knowledge information DB

1. A support apparatus for supporting a specific task, the support apparatus comprising:
a processor; and
a memory having instructions stored thereon that, when executed by the processor, cause the processor to:
store organization information indicating a relationship between a hierarchical structure of an organization and a plurality of users belonging to the organization, where the plurality of users includes a user and another user; and
when the user initiates a user interface of a chat about supporting the specific task being performed by the user, automatically identify, based on the organization information, said another user who will be a partner of the chat for the user.

2. The support apparatus according to claim 1,
wherein the identifying operation further includes
identifying said another user who belongs to a section of the organization, to which the user belongs, and who monitors a task of the user, and
identifying the identified another user as the partner of the chat.

3. The support apparatus according to claim 2,
wherein the identifying operation further includes, when the identified another user is not available for the chat,
identifying yet another user belonging to a section of the organization that is at one level higher than the section of the organization to which the user belongs, and
identifying the identified yet another user as the partner of the chat.

4. The support apparatus according to claim 1,
wherein the specific task includes responding to a phone call in a contact center or a call center, and
wherein the identifying operation further includes
when an operator initiates a chat with another user,
identifying a supervisor belonging to a section of the organization to which the operator belongs with reference to the organization information, and
identifying the identified supervisor as the partner of the chat.

5. The support apparatus according to claim 1,
wherein the instructions further cause the processor to:
generate knowledge information that is composed of question sentences and answer sentences based on voice recognition texts that are a voice recognition result of a voice call between two users, and messages of the chat sent during the voice call.

6. The support apparatus according to claim 5,
wherein the instructions further cause the processor to:
after associating the voice recognition texts and the messages in chronological order, extract the question sentences and the answer sentences from the voice recognition texts and the messages based on nature of the specific task; and
generate the knowledge information using the extracted question sentences and the extracted answer sentences.

7. The support apparatus according to claim 6,
wherein the specific task includes responding to a phone call in a contact center or a call center, and
wherein the instruction further case the processor to
extract, among the voice recognition texts appearing before a first message of the messages, a voice recognition text and the first message as the question sentences, where the voice recognition text represents at least one of: an inquiry speech of a customer, a question speech of a customer, a repetition speech of an operator for the inquiry speech, and a repetition speech of the operator for the question speech; and
extract the answer sentences that includes
the massages sent by the supervisor appearing after the message extracted as the question sentence, and
the voice recognition texts appearing after an end of the chat, where the voice recognition texts represent an explanatory speech of the operator.

8. The support apparatus according to claim 1,
wherein the instructions further cause the processor to:
associate voice recognition texts and messages of the chat during the voice call in chronological order, where the voice recognition texts are a voice recognition result of the voice call between the two users; and
generate display information of a screen for displaying the voice recognition texts and the messages, which are associated with one another.

9. The support apparatus according to claim 8,
wherein the instructions further cause the processor to associate the voice recognition texts and the messages that are processed by a predetermined filtering process in chronological order.

10. The support apparatus according to claim 8,
wherein the instructions further case the processor to generate the display information of the screen that is a screen on which the voice recognition texts or the messages are not displayed, and
wherein the screen includes one or more link buttons for displaying the voice recognition texts or the messages that are not displayed.

11. A method for supporting a specific task by a support apparatus, the method comprising:
storing organization information in a storage, the organization information representing a relationship between a hierarchical structure of organizations and a plurality of users belonging to the organizations, where the plurality of users include a user and another user; and
when the user initiates a user interface of a chat about supporting the specific task being performed by the user, automatically identifying, based on the organization information, said another user who will be a partner of the chat for the user.

12. A non-transitory recording medium storing a program that, when executed on a computer, causes the computer to perform the support method of claim 11.
